(19) United States
(12) Patent Application Publication
(10) Pub. No.: US 2007/0131074 A1
(43) Pub. Date: Jun. 14, 2007

(54) IMPROVED HOLE-PUNCHING MACHINE

(76) Inventor: Chou-Chih Chiang, Taichung (TW)

Correspondence Address: PAI PATENT & TRADEMARK LAW FIRM, 1001 FOURTH AVENUE, SUITE 3200, SEATTLE, WA, 98154, US

(21) Appl. No.: 11/164,936

(22) Filed: Dec. 12, 2005

(51) Int. Cl. B26F 1/14

(52) U.S. Cl. 83/628; 83/687

(57) ABSTRACT

An improved hole-punching machine is disclosed. The improved hole-punching machine of the present invention comprises a motor unit, a push unit, a compression unit and a hole-punching unit. The hole-punching unit is detachably held by a fixing unit in the machine. When the fixing unit disengages the hole-punching unit, the hole-punching unit may be taken out from the machine. The hole-punching unit comprises two balancing rods, a holes-positioning piece, two elastic pieces, a plurality of punching pieces, a first balancing piece (with a reinforcement piece), a second balancing piece (with a reinforcement piece) and a third balancing piece (with a reinforcement piece), wherein the first, second and third balancing pieces are connected together. Hence, the improved hole-punching machine of the present invention has the advantages of lower production cost, a higher efficiency in production and a higher economic value.

### BACKGROUND OF THE INVENTION

1. Field of the invention

The invention generally relates to a hole-punching machine. More particularly, the invention relates to an improved hole-punching machine with a hole-punching unit that may be fitted and detached easily. The machine has the advantages of simplified manufacturing process, lower production cost, a higher efficiency in production, easy assembly, ease of use, easy maintenance (namely, if a part of the hole-punching unit is damaged, only that part needs to be replaced) and a higher economic value.

2. Description of the Related Art

As of now, in addition to the two-hole punching device, there are multiple-hole punching devices. Because a multiple-hole punching device has more punching pieces and needs to hold a stack of paper and set it into a neat condition, such a device has a larger and more complicated structure than a two-hole punching device. Hence, such a device has a higher production cost and a user needs to press harder when using it.

In the prior art multiple-hole punching device, its punching unit is replaceable. Because the punching unit is made of iron and has a predetermined thickness, more material is needed in the production. Such a punching unit is provided with a shreds storing slot. An electricity discharge process, which takes much time and effort, is used in the manufacturing of the shreds storing slot. After the shreds storing slot is manufactured, a positioning piece has to be fitted. Hence, it takes a long time to manufacture a punching unit and the production cost of a punching unit remains quite high. Because the punching unit of a multiple-hole punching device may have different types and numbers of holes, a user has to pay a high price for a replacement punching unit.

In addition, the punching unit of the prior art multiple-hole punching device is made of iron and is provided with a shreds storing slot and a paper slot; if the shreds storing slot or the paper slot is damaged during the production or when in use, the punching unit would be rendered unusable and has to be discarded.

Therefore, the high production cost of the prior art punching unit needs to be reduced and the difficult manufacturing process for such a punching unit needs to be improved. Also, the prior art multiple-hole punching device needs to be made more user-friendly.

To eliminate the disadvantages of the prior art, the inventor has put in a lot of effort in the subject and has successfully come up with the improved hole-punching machine of the present invention. The improved hole-punching machine of the invention has a hole-punching unit that may be fitted and detached easily and, as a result, the machine has the advantages of simplified manufacturing process, substantially lower production cost, higher efficiency in production, ease of use, easy maintenance and a higher economic value.

### SUMMARY OF THE INVENTION

The object of the present invention is to provide an improved hole-punching machine. The improved hole-punching machine of the present invention comprises a housing, a motor unit, a push unit, a compression unit, a hole-punching unit and a fixing unit. The rotation generated by the motor unit (which may be either manually operated or power operated) may be passed on to the push unit, which in turn presses against the compression unit, which presses against the hole-punching unit. The hole-punching unit is detachably held in the housing by the fixing unit and may be detached from the housing when the fixing unit disengages it. The hole-punching unit comprises two balancing rods, a holes-positioning piece, two elastic pieces, a plurality of punching pieces, a first balancing piece (with a reinforcement piece), a second balancing piece (with a reinforcement piece) and a third balancing piece (with a reinforcement piece), wherein the first, second and third balancing pieces are connected together. Each of the holes-positioning piece and the reinforcement pieces have a row of holes to allow the punching pieces to go through. An elongated slot is provided on each of the first, second and third balancing pieces. An indentation area is provided on one side of each balancing piece so as to hold a reinforcement piece such that the reinforcement piece may be in flush with the corresponding balancing piece and the three balancing pieces may be joined together. Also, a gap is provided between the second balancing piece and the third balancing piece so that a stack of paper may be inserted in the gap.

Therefore, the first, second and third balancing pieces (each being fitted with a reinforcement piece) may be connected together. The first, second and third balancing pieces as well as the reinforcement pieces are preferably made of aluminum; alternatively, the second and third balancing pieces are made of aluminum, but the reinforcement pieces are made of other material. Hence, the cost of the material used for the first, second and third balancing pieces as well as the reinforcement pieces is inexpensive; also, only a single stamping operation is needed to form the holes of the reinforcement pieces or the elongated slots of the balancing pieces after the balancing pieces and reinforcement pieces are formed by extrusion. Hence, the production cost of the hole-punching unit is lowered. In addition, the efficiency in production is enhanced, and a higher economic value is achieved.

### BRIEF DESCRIPTION OF THE DRAWINGS

The drawings disclose an illustrative embodiment of the present invention which serves to exemplify the advantages and objects hereof, and are as follows:

FIG. 1 is a perspective view showing the overall structure of the hole-punching machine of the present invention.

FIG. 2 is a partial sectional view showing the hole-punching machine of the present invention.

FIG. 3 is a top view showing the hole-punching machine of the present invention.

FIG. 4 is a perspective view showing the hole-punching unit of the hole-punching machine of the present invention.

FIG. 5 is an exploded view showing the hole-punching unit of the hole-punching machine of the present invention.

FIG. 6 is a partial sectional view showing the hole-punching unit of the hole-punching machine of the present invention.

FIG. 7 is a sectional view showing the hole-punching unit of the hole-punching machine of the present invention being in use.

### DETAILED DESCRIPTION OF THE PREFERRED EMBODIMENT

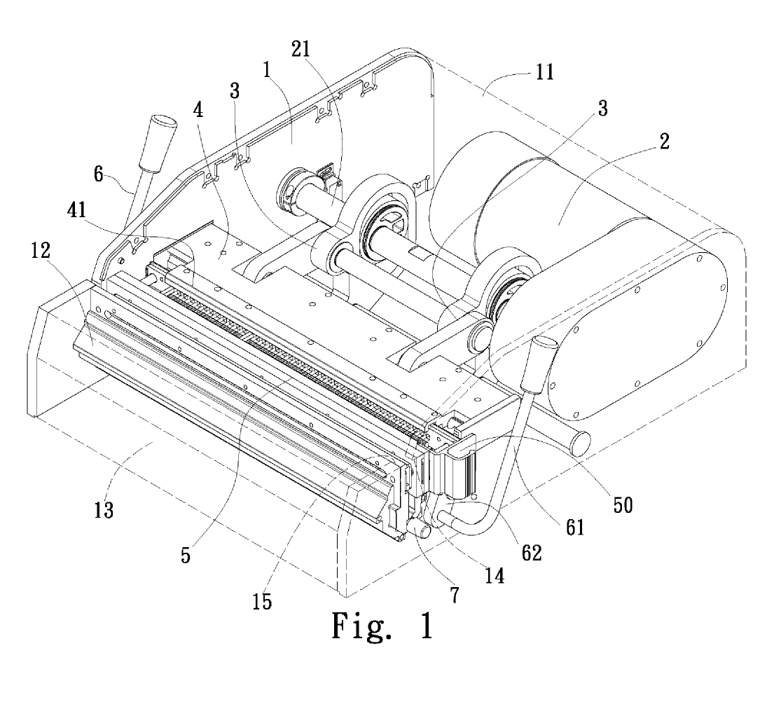

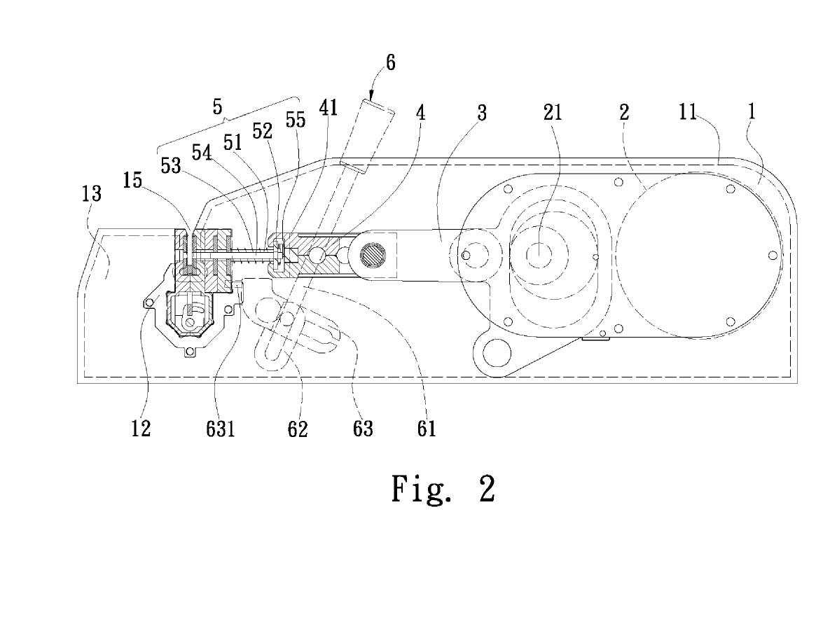

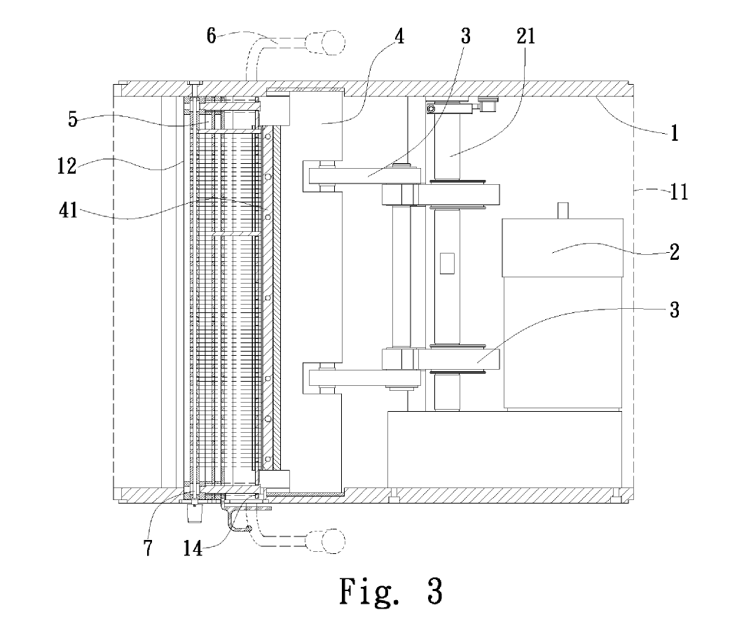

FIG. 1 is a perspective view showing the overall structure of the hole-punching machine of the present invention. FIG. 2 is a partial sectional view showing the hole-punching machine of the present invention. FIG. 3 is a top view showing the hole-punching machine of the present invention.

The hole-punching machine of the present invention comprises a housing 1, a motor unit 2, a push unit 3, a compression unit 4, a hole-punching unit 5 and a fixing unit 6.

The motor unit 2, the push unit 3, the compression unit 4, the hole-punching unit 5 and the fixing unit 6 are held in the housing 1. The housing 1 may also include a closure type cover 11, a protective cover 12 (which serves to protect the hole-punching unit 5), a shreds storing area 13, an access opening 14 (so that the hole-punching unit 5 may enter the housing 1) and a gap 15 (so that a stack of paper to be punched may be placed in the gap 15).

The motor unit 2 comprises an electric motor. The motor unit 2 is fixedly disposed in the housing 1, and an output axle 21 connected with the motor unit 2 is pivotally connected with an inner wall of the housing 1. The output axle 21 is connected with the push unit 3. Alternatively, the motor unit 2 may be replaced by a manually operated device.

One end of the push unit 3 is connected with the output axle 21 of the motor unit 2, and the other end of the push unit 3 is connected with the compression unit 4.

The two ends of the compression unit 4 are fixed in the shreds storing area 13, and the compression unit 4 has an action portion 41. The hole-punching unit 5 may be inserted into the action portion 41.

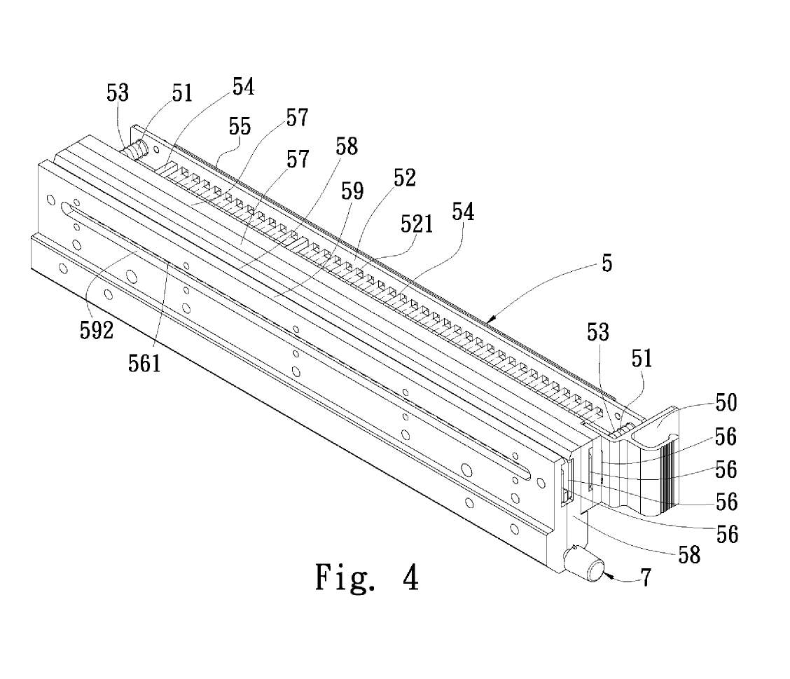

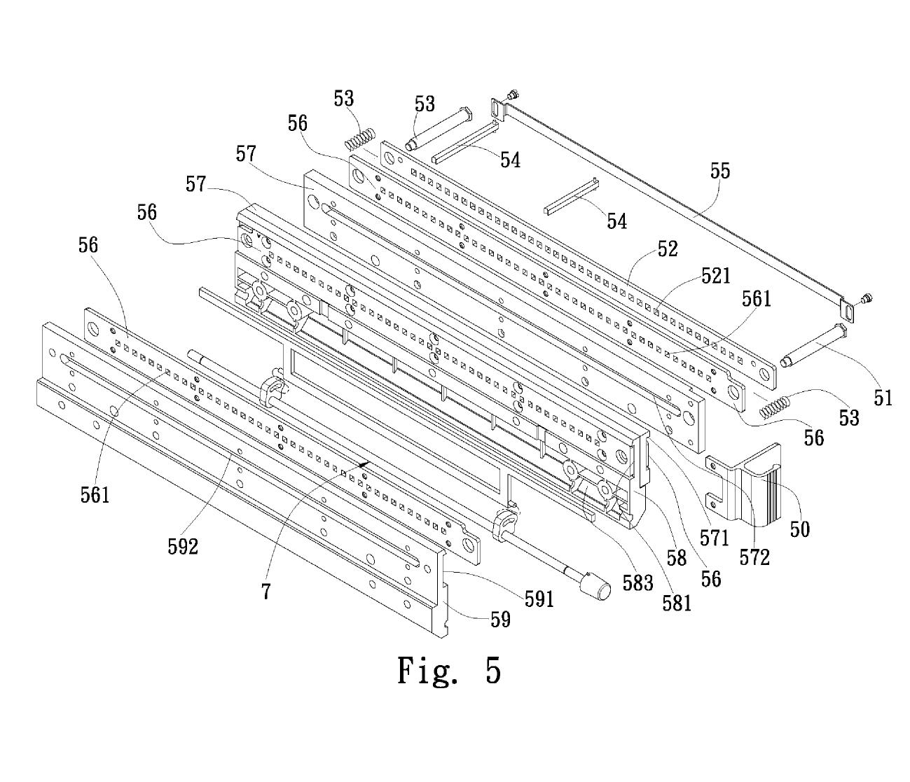

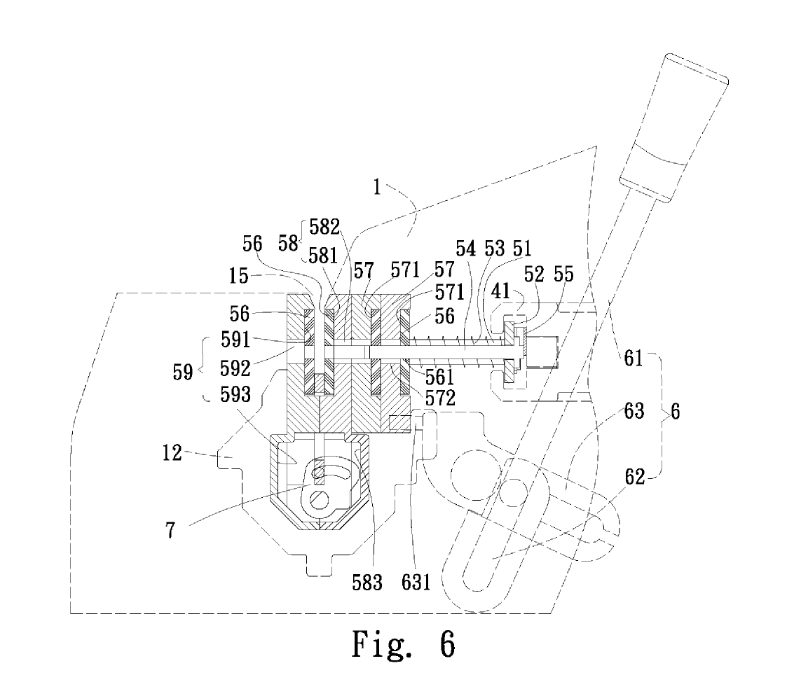

Referring to FIGS. 4, 5 and 6 (FIG. 4 is a perspective view showing the hole-punching unit of the hole-punching machine of the present invention; FIG. 5 is an exploded view showing the hole-punching unit of the hole-punching machine of the present invention; FIG. 6 is a partial sectional view showing the hole-punching unit of the hole-punching machine of the present invention), the hole-punching unit 5 comprises two balancing rods 51, a holes-positioning piece 52, two elastic pieces 53, a plurality of punching pieces 54, a retaining piece 55, a first balancing piece 57 (with a reinforcement piece 56), a second balancing piece 58 (with a reinforcement piece 56), a third balancing piece 59 (with a reinforcement piece 56) and a grip piece 50.

The two balancing rods 51 are inserted into the holes-positioning piece 52, the two elastic pieces 53, the retaining piece 55, the first balancing piece 57 and the second balancing piece 58. One end of each balancing rod 51 is held on the holes-positioning piece 52, and the other end is held on the second balancing piece 58.

The holes-positioning piece 52 is a thin plate with a row of holes 521, which allow the punching pieces 54 to go through. One larger hole is provided on each end of the holes-positioning piece 52 to allow the two balancing rods 51 to go through.

Each of the two balancing rods 51 is inserted into an elastic piece 53. One end of each elastic piece 53 presses against the holes-positioning piece 52, and the other end presses against the reinforcement piece 56 so that the holes-positioning piece 52 and the reinforcement piece 56 are separated by the two elastic pieces 53.

The number and shape of the punching pieces 54 may be altered according to the actual need. The punching pieces 54 are inserted into the holes-positioning piece 52, the reinforcement piece 56 and the first balancing piece 57. One end of each punching piece 54 is held on the holes-positioning piece 52.

The retaining piece 55 is fixed on the holes-positioning piece 52 and holds the distal end of each punching piece 54 in place.

Each reinforcement piece 56 is a rectangular plate preferably made of aluminum. A larger hole is provided on each of the two ends of each reinforcement piece 56 to allow the two balancing rods 51 to go through. A row of holes 561 is provided on each reinforcement piece 56 to allow the punching pieces 54 to go through. (Four or more reinforcement pieces 56 are used in the present embodiment.)

The first balancing piece 57 is a rectangular plate preferably made of aluminum. Two larger holes are provided on the first balancing piece 57 to allow the two balancing rods 51 to go through. An indentation area 571 is provided on one side of the first balancing piece 57. An elongated slot 572 is provided on the first balancing piece 57 so that the punching pieces 54 may go through. (Two or more first balancing pieces 57 may be used in the present embodiment.)

The second balancing piece 58 is a plate preferably made of aluminum. Two larger holes are provided on the second balancing piece 58 to allow the two balancing rods 51 to go through. An indentation area 581 is provided on one side of the second balancing piece 58 so as to hold a reinforcement piece 56. The indentation area 581 is deeper than the indentation area 571 so that a stack of paper may be inserted. An elongated slot 582 is provided on the second balancing piece 58 so that the punching pieces 54 may go through. The lower portion of the second balancing piece 58 and the lower portion of the third balancing piece 59 jointly form a space 583 and 593 so as to hold a peripheral distance adjusting unit 7.

The third balancing piece 59 is a plate preferably made of aluminum and is disposed next to the second balancing piece 58. An indentation area 591 is provided on one side of the third balancing piece 59 so as to hold a reinforcement piece 56. The indentation area 591 is deeper than the indentation area 571 so that a stack of paper may be inserted. An elongated slot 592 is provided on the third balancing piece 59 so that the punching pieces 54 may go through. The lower portion of the second balancing piece 58 and the lower portion of the third balancing piece 59 jointly form a space 583 and 593 so as to hold the peripheral distance adjusting unit 7.

The grip piece 50 is disposed on one end of the first balancing piece 57 so that a user may use it to move the hole-punching unit 5.

The fixing unit 6 comprises a handle 61, a connecting piece 62 and a fastening piece 63. The upper portion of the handle 61 is outside the housing 1 so that a user may grip it. The lower portion of the handle 61 is inside the housing 1 and is connected to the connecting piece 62. One end of the fastening piece 63 is connected with the connecting piece 62, and the other end forms a fastening portion 631, which may be used to fix or unfasten the hole-punching unit 5.

Now, please refer to FIGS. 2, 3 and 6 (FIG. 2 is a partial sectional view showing the hole-punching machine of the present invention; FIG. 3 is a top view showing the hole-punching machine of the present invention; FIG. 6 is a partial sectional view showing the hole-punching unit of the hole-punching machine of the present invention).

We will now describe how the hole-punching machine is assembled. First, the motor unit 2 is fitted in the housing 1 and its output axle 21 is pivotally connected with an inner wall of the housing 1. Also, the output axle 21 is connected with the push unit 3. Hence, the rotation may be transmitted to the push unit 3 and then to the compression unit 4. The two ends of the compression unit 4 are fixed in the shreds storing area 13.

Next, insert the reinforcement pieces 56 into the indentation area 571 and the indentation area 581 so that each reinforcement piece 56 is in flush with the corresponding balancing pieces 57 and 58. Then, connect the first balancing piece 57 and the second balancing piece 58 (with screws or bolts). Next, connect the second balancing piece 58 with the third balancing piece 59 by lining up the indentation area 581 with the indentation area 591 so that a gap for inserting a stack of paper is provided between the reinforcement piece 56 of the second balancing piece 58 and the reinforcement piece 56 of the third balancing piece 59. The peripheral distance adjusting unit 7 may then be placed inside the space 583 and 593.

Now, align each of the two balancing rods 51 with the corresponding larger hole provided on each end of the holes-positioning piece 52. Then allow the two balancing rods 51 to be inserted into the holes-positioning piece 52, the two elastic pieces 53, the first balancing piece 57 and the second balancing piece 58 such that one end of each balancing rod 51 is held on the holes-positioning piece 52, and the other end is held on the second balancing piece 58. Connect the third balancing piece 59 with the second balancing piece 58. Then, insert the punching pieces 54 into the holes 521 of the holes-positioning piece 52 and the elongated slot 572 of the first balancing piece 57. Connect the grip piece 50 with the first balancing piece 57. Connect the retaining piece 55 with the holes-positioning piece 52 so as to hold the distal ends of the punching pieces 54 in place. Now, the hole-punching unit 5 is assembled.

Next, move the assembled hole-punching unit 5 into the housing 1 through the access opening 14 so that the holes-positioning piece 52 and the retaining piece 55 may enter the action portion 41 of the compression unit 4; that the first, second and third balancing pieces 57, 58 and 59 may be enclosed by the protective cover 12; and that the grip piece 50 extends out of the housing 1. Now, rotate the handle 61 for a certain angle so as to move the fastening piece 63 via the connecting piece 62 so that the fastening portion 631 may fix the hole-punching unit 5 in place.

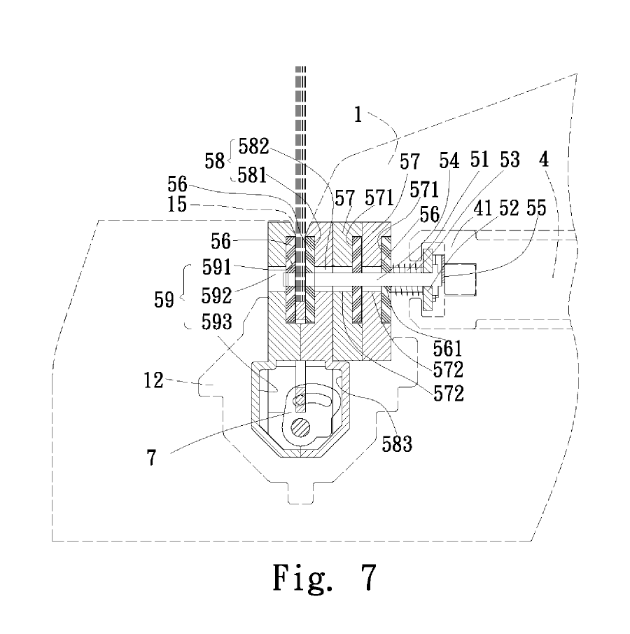

Now, please refer to FIGS. 7 and 2 (FIG. 7 is a sectional view showing the hole-punching unit of the hole-punching machine of the present invention in use; FIG. 2 is a partial sectional view showing the hole-punching machine of the present invention).

We will now describe how the hole-punching machine is used. First, insert a stack of paper into the gap formed by and between the second balancing piece 58 and the third balancing piece 59. Next, turn on the motor unit 2 (or use a manually operated device). Now, the rotation may be passed through the output axle 21 to the push unit 3, which in turn presses against the compression unit 4, which presses against the holes-positioning piece 52 and the retaining piece 55, which forces the punching pieces 54 to enter the elongated slot 572 of the first balancing piece 57 and the row of holes 561 provided on the reinforcement pieces 56 of the second and third balancing pieces 58 and 59. Now, the stack of paper is punched with a row of holes.

In the hole-punching machine of the present invention, the first, second and third balancing pieces 57, 58 and 59 (each being fitted with a reinforcement piece 56) are connected together. The first, second and third balancing pieces 57, 58 and 59 as well as the reinforcement pieces 56 are preferably made of aluminum; alternatively, the second and third balancing pieces 57, 58 and 59 are made of aluminum, but the reinforcement pieces 56 are made of other material. Hence, the cost of the material used for the first, second and third balancing pieces 57, 58 and 59 as well as the reinforcement pieces 56 is inexpensive; also, only a single stamping operation is needed to form the row of holes 561 of reinforcement pieces 56 or the elongated slots 572, 582 and 592 after these pieces 56, 57, 58 and 59 are formed by extrusion. Hence, the production cost of the hole-punching unit 5 is lowered. In addition, these pieces 56, 57, 58 and 59 may be assembled easily and quickly; hence, such a hole-punching unit 5 and the hole-punching machines equipped with it may be produced swiftly and relatively efficiently. Furthermore, the production cost of such machines is lowered because the reinforcement pieces have the same size and pattern of holes and the pieces 57, 58 and 59 have the same kind of elongated slot.

In contrast to the previously described hole-punching machine of the prior art, the hole-punching machine of the present invention is characterized as follows: (1) the pieces 56, 57, 58 and 59 of the hole-punching unit 5 are made of aluminum; (2) only a single stamping operation is needed to form the row of holes 561 of reinforcement pieces 56 or the elongated slots 572, 582 and 592; (3) the pieces 56, 57, 58 and 59 are connected together so that the strength of the hole-punching unit 5 is enhanced; (4) with the design of the hole-punching unit 5, the cost of the material used for the pieces 56, 57, 58 and 59 is inexpensive, and the production cost of the hole-punching unit 5 is lowered; (5) the hole-punching unit 5 can be more easily fabricated and assembled than the prior art hole-punching unit; (6) the structure of the hole-punching unit 5 allows just the damaged piece to be replaced if any of the pieces 56, 57, 58 and 59 is damaged as opposed to having to replace the whole hole-punching unit for the prior art machine if this happens; and (7) the design of the hole-punching unit 5 enhances the economic value of the hole-punching machine.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A hole-punching machine, comprising:
a housing;
a motor unit, disposed inside the housing;
a push unit, connected with the motor unit;
a compression unit, connected with the push unit; and
a hole-punching unit, connected with the compression unit and fixedly held in the housing, comprising:
two balancing rods;
a plurality of punching pieces;
a holes-positioning piece, which has a row of holes so as to allow the plurality of punching pieces to go through, and a hole on each end thereof so as to allow the two balancing rods to go through;
two elastic pieces;
a retaining piece, which is fixed on the holes-positioning piece and holds the distal end of each punching piece in place;
a plurality of reinforcement pieces, each of which is a rectangular plate and is provided with a row of holes so as to allow the punching pieces to go through;
a first balancing piece, which is a rectangular plate made of aluminum with an indentation area provided on one side thereof to receive one of the reinforcement pieces and with an elongated slot for the punching pieces to go through;
a second balancing piece, which is a plate made of aluminum with an indentation area provided on one side thereof to receive one of the reinforcement pieces and with an elongated slot for the punching pieces to go through, and which is connected with the first balancing piece; and
a third balancing piece, which is a plate made of aluminum with an indentation area provided on one side thereof to receive one of the reinforcement pieces and with an elongated slot for the punching pieces to go through, and which is connected with the second balancing piece to form a gap between the second balancing piece and the third balancing piece so that a stack of paper may be inserted into the gap, wherein the two balancing rods are inserted into the holes-positioning piece through the two holes on the two ends thereof, the two elastic pieces, the retaining piece, the first balancing piece and the second balancing piece, with one end of each balancing rod held on the holes-positioning piece and the other end held on the second balancing piece;
the plurality of punching pieces are inserted through the row of holes on the holes-positioning piece, the row of holes on the reinforcement piece received in the indentation area of the first balancing piece and the elongated slot of the first balancing piece, with one end of each punching piece being held on the holes-positioning piece; and
one end of each elastic piece presses against the holes-positioning piece and the other end presses against the reinforcement piece received in the indentation area of the first balancing piece so that the holes-positioning piece and the reinforcement piece are separated by the two elastic pieces.

2. The hole-punching machine as in claim 1, wherein the motor unit is electrically operated.

3. The hole-punching machine as in claim 1, wherein the motor unit is manually operated.

4. The hole-punching machine as in claim 1, wherein the housing has an access opening so that the hole-punching unit may be fitted into or taken out from the machine through the access opening.

5. The hole-punching machine as in claim 1, wherein the hole-punching machine further includes a fixing unit which fastens the hole-punching unit when the hole-punching unit is fitted inside the housing.

6. The hole-punching machine as in claim 5, wherein the fixing unit comprises a handle, a connecting piece and a fastening piece, with the upper portion of the handle being outside the housing and the lower portion of the handle being inside the housing and connected to the connecting piece, and one end of the fastening piece being connected with the connecting piece and the other end of the fastening piece forming a fastening portion, which may be used to fasten or unfasten the hole-punching unit.

7. The hole-punching machine as in claim 1, wherein the hole-punching unit further includes a grip piece, which is disposed on one end of the first balancing piece so that a user may use it to move the hole-punching unit.

8. The hole-punching machine as in claim 1, further comprising at least one additional first balancing piece.

9. The hole-punching machine as in claim 1, wherein the lower portion of the second balancing piece and the lower portion of the third balancing piece jointly form a space so as to hold a peripheral distance adjusting unit.
